(19) United States
(12) Patent Application Publication
(10) Pub. No.: US 2026/0359411 A1
(43) Pub. Date: Nov. 12, 2026

(54) ACCESS CONTROL SYSTEMS AND METHODS USING A FINGERPRINT READER

(71) Applicant: Telefonaktiebolaget LM Ericsson (publ), Stockholm (SE)

(72) Inventors: Peter ÖKVIST, LULEÅ (SE); Tommy ARNGREN, SÖDRA SUNDERBYN (SE); Alexander HUNT, LUND (SE)

(73) Assignee: Telefonaktiebolaget LM Ericsson (publ), Stockholm (SE)

(21) Appl. No.: 19/515,696

(22) PCT Filed: Sep. 5, 2023
(86) PCT No.: PCT/EP2023/074223

§ 371 Date: Mar. 2, 2026

(51) Int. Cl. G06F 21/32; G06F 3/044; G06T 11/60; G06V 40/12; G06V 40/13

(52) U.S. Cl. CPC G06F 21/32; G06T 11/60; G06V 40/13; G06V 40/1365; G06F 3/044; G06T 2210/12

(57) ABSTRACT

A method for access control. The method includes displaying on a display screen of a device an image of an anchor object (AO) that was previously selected by or for an authorized user of the device. The method also includes obtaining fingerprint information corresponding to a fingerprint of a user seeking to access the device or a resource guarded by the device. The method also includes determining that an access condition is satisfied. The method also includes granting the user access to the device or the resource as a result of determining that the access condition is satisfied. Determining that the access condition is satisfied includes determining that the user has touched the display screen in an activation area associated with the AO; and determining, based on the obtained fingerprint information, that the fingerprint of the user seeking to access the device matches a fingerprint of the authorized user.

### TECHNICAL FIELD

Disclosed are embodiments related to access control.

### BACKGROUND

There are several solutions for controlling access to a device so that the device is not used by an unauthorized user. These solutions include, for example, use of a personal identification number (PIN), use of a password, and use of a user selected swipe pattern (e.g., a user swiping a finger over the device's display screen in a swipe-over-dots-pattern-snake manner as available with many android devices). Other solutions consider the user's interaction with surfaces, segments and patches of a rendered three-dimensional (3D) object (such as a cube) where the user is requested to provide, for example, an N-tap sequence mapped over, for example, N-colors each located over N different sides as described in US Patent Publication No. 2014013414A1.

Other yet more elaborate solutions may include a more generic finger-touch sequence overlayered on a user/application selected image, such as tapping a number of user predefined identified and segmented objects in a specific in order e.g. as cat2-red ball-car-kid3-dog1-cat2-cat2), and where said objects' respective location in the selected image (hence the screen) intentionally and naturally differ between used images. Yet other solutions consider use of fingerprint recognition or face recognition, or combinations thereof.

### Object Detection, Recognition, and Segmentation

Object detection and classification capabilities are increasing in today's devices and solutions; today's state-of-the-art (SoTA) solutions are typically capable of recognizing several (e.g., thousands or hundreds of thousands) of objects spread over many object categories.

Apple, Inc. describes capabilities in recognizing objects in live capture/streams using Vision framework to identify objects in real-time video starting from iOS 12, macOS 10.14, and tvOS 12. It is stated that Vision-requests made with a core machine learning (ML) models return results as “VNRecognizedObjectObservation” objects, which identify objects found in the captured scene, where the VNRecognizedObjectObservation is a detected object observation with an array of classification labels that classify the recognized object.

Amazon (AWS) Recognition (see, e.g., reference [9]) provides a service for processing image data with respect to image features, where key features provided are described as: (1) Label detection and image properties (detects objects, scenes, activities, and landmarks), (also detects dominant colors and measures image brightness, sharpness, and contrast); (2) Facial recognition (finds similar faces in a large collection of images); (3) Facial analysis (locates faces within images and analyze face attributes, such as whether or not the face is smiling, or the eyes are open); (4) Face comparison (measures the likelihood that faces in two images are of the same person); (5) Unsafe image detection (detects explicit and suggestive content so that you can filter images based on your application requirements); (6) Celebrity recognition (detects and recognizes thousands of individuals who are famous, noteworthy, or prominent in their field); (7) Text in image (locate and extract text within images, including text in natural scenes such as road signs or license plates, text over objects such as t-shirts or mugs, and text on screen such as captions or news); and (8) Personal protective equipment (PPE) detection (detects if persons are wearing PPE, face covers, hand covers, and head covers, and whether the protective equipment covers the corresponding body part).

Other implementations such as YOLO (see, e.g., references [7, 8]) are available for real-time object detection using constrained devices such as e.g., smartphone, where for example using training imagery data set ‘COCO 2017’ up to 143 k images are used for training over 80 object classes, ‘wildlife’ up to 24 k images in 67 classes, ‘football performance’ about 34 k images in 3 object classes, etc.

In above mentioned technology areas, the difference between ‘object detection’ and ‘image segmentation’ may be noticed (see, e.g., references [10][11]). Object detection often refers to the art of predicting bounding boxes for objects in an image, typically seen as identifying rectangles around specific objects in images. One SoTA algorithm is YOLO (see, e.g., references [7,8]). Image segmentation often relates to the art of predicting masks, i.e., making the object indicator less boxy and annotate the image “pixel by pixel.” Essentially, a mask represents an image of same size as the original image, but for each pixel, it has in the basic arrangement a binary Boolean value indicating whether the object is present or not present. In more elaborate approaches, multiple logical categorizations are also available.

### Full Screen Fingerprint Reading

Today's mobile device screens are equipped with fingerprint scanning mechanisms. Usually, the scanning is done by producing a digital image of a fingertip using a light-sensitive microchip (either a CCD, charge-coupled device, or a CMOS image sensor) or using capacitive or ultrasonic scanners and obtaining a fingerprint from the image. Those scanners are usually localized just to a particular part of the screen, not the whole screen. Device manufacturers are planning on introducing a fingerprint scanner that spans a large section, if not the entire display screen (see e.g., references [12][13]).

### SUMMARY

Certain challenges presently exist. For instance, as with any pattern sequence being physically entered into a device, a PIN code and/or pass sequence will work for anyone having that information even if that person is not the authorized user. Similar, side-view peeking vulnerabilities and security drawbacks apply with other similar solutions where user applies a finger-swipe pattern over the screen to render a specific user-selected connect-the-dots manner. Generally, for example, in a brute-force attack where the attacker tries to apply a fake fingerprint on the fingerprint reader, a first challenge to the attacker is to determine where the device's fingerprint reader is deployed and hence where to poke whatever “fake finger” has been constructed. With today's solutions, this will typically be rather straightforward given that the fingerprint reader is typically installed in plain sight or visually indicated or in a well-known location.

Accordingly, in one aspect there is provided an improved method for access control, which method utilizes a fingerprint reader. The method includes displaying on a display screen of a device an image of an anchor object (AO) that was previously selected by or for an authorized user of the device. The method also includes obtaining fingerprint information corresponding to a fingerprint of a user seeking to access the device or a resource guarded by the device. The method also includes determining that an access condition is satisfied. The method also includes granting the user access to the device or the resource as a result of determining that the access condition is satisfied. Determining that the access condition is satisfied includes determining that the user has touched the display screen in an activation area associated with the AO and determining, based on the obtained fingerprint information, that the fingerprint of the user seeking to access the device matches a fingerprint of the authorized user.

In another aspect there is provided a computer program comprising instructions which when executed by processing circuitry of a device causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided a device that is configured to perform the methods disclosed herein. The device may include memory and processing circuitry coupled to the memory.

An advantage of the embodiments disclosed herein is that they increase security by making it difficult for an unauthorized user to activate the fingerprint reader (e.g., to determine the correct location to place a fingertip to be read by the fingertip sensor).

### BRIEF DESCRIPTION OF THE DRAWINGS

The accompanying drawings, which are incorporated herein and form part of the specification, illustrate various embodiments.

FIG. 1 illustrates a device according to an embodiment.

FIG. 2A illustrates a functional block diagram of the device.

FIG. 2B illustrates a functional block diagram of an access control application (ACA) according to an embodiment.

FIG. 3 is a flowchart illustrating a process according to an embodiment.

FIG. 4 is a flowchart illustrating a process according to an embodiment.

FIG. 5 is a flowchart illustrating a process according to an embodiment.

FIG. 6 is a block diagram of a device according to an embodiment.

### DETAILED DESCRIPTION

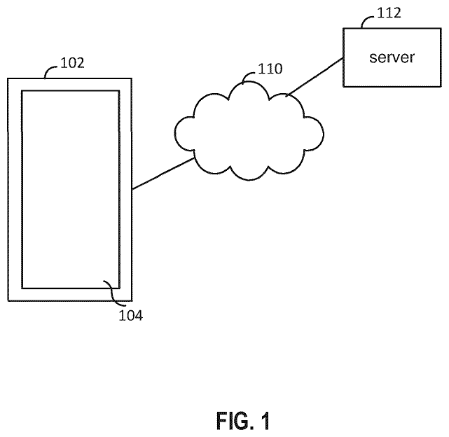

FIG. 1 illustrates a device 102 (e.g., a smartphone, a tablet, an appliance, an Internet-of-Things (IOT) device, an electronic lock or other electronic access device, etc.) according to an embodiment. Device 102 includes a display screen 104 (e.g., a touchscreen display). In some embodiments, in addition to having display screen 104, device 102 may have other touch sensitive surfaces (e.g., the back of device 102 may be touch sensitive). Device 102 may also have networking capability enabling device 102 to communicate (e.g., wirelessly communicate), via a network 110 (e.g., the internet), with a remote server 112. An authorized user of device 102 (e.g., the owner of the device or any other person granted administrative capabilities over the device) may desire to control who may use device 102 (or, in the case device 102 is an access device, the resource to which the access device can provide access-i.e., the resource “guarded” by device 102). Accordingly, the authorized user may activate an access control feature of device 102.

As noted above, there are today a number of access control features that are available, including use of a 4-digit PIN code and/or use of fingerprint reader. The use of a fingerprint reader may provide more protection from unauthorized use than a PIN code due to the fact that PIN codes can be guessed. It is also possible, however, for an attacker to create a synthetic fingerprint to fool device 102′s fingerprint reader. Accordingly, to make it more difficult for an attacker to gain access to device 102 when the device's fingerprint reader is used to control access, in the embodiments disclosed herein, the attacker must not only generate a synthetic fingerprint matching an authorized fingerprint, but also must have knowledge of a secret object known to the authorized user. This secret object is referred to herein as an “anchor object (AO).”

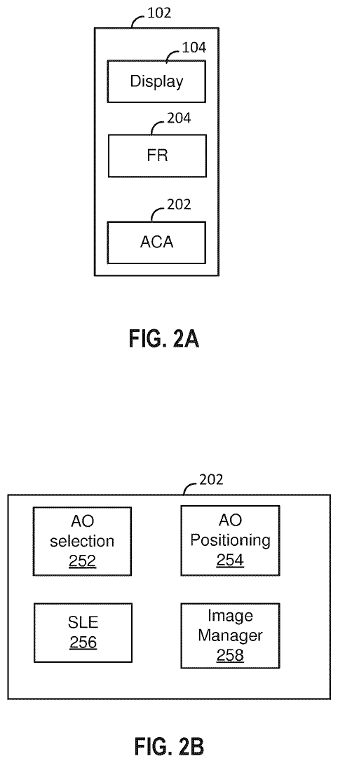

FIG. 2A illustrates a functional block diagram of device 102 according to an embodiment. In this embodiment, device 102 includes display 104, which is a touchscreen display in this embodiment, an access control application (ACA) 202 that controls access to device 102, and a fingerprint reader (FR) 204, which is controlled by ACA 202. Touchscreen display 104 may be of capacitive technology overlaid and aligned with an LCD or OLED display or other type of display technology. Fingerprint reader 204 may be co-located with display 104 and may be deployable over the entire display or part of the display. The position of the fingerprint reader may be based on the technology used (e.g., optical and ultrasound fingerprint readers are placed below the display screen, while a capacitive fingerprint reader is placed above the display screen). In other embodiments, fingerprint reader 204 is not deployed over any part of the display, but rather deployed on another touch sensitive surface of device 102. ACA 202 may be software having one or more modules that run on dedicated processing circuitry (e.g., dedicated integrated circuit) and communicate with fingerprint reader 204 through a secure element (SE) (e.g., a secure enclave).

FIG. 2B illustrates a functional block diagram of ACA 202 according to an embodiment. In this embodiment, ACA 202 comprises several modules described below.

The AO selection module 252 is a module that the authorized user interacts with to select an AO. For example, in one embodiment, AO selection module 252 has access to a collection of photographs stored on device 102 and allows the user to browse through the photographs to select the AO. For example, if the user wants the AO to be a red ball or a particular person, the user can browse through the photographs until a photo containing the AO is found. Once such photo is found, the user can inform the AO selection module 252 of the desired AO by taping on the AO in the photograph. Accordingly, in one embodiment, the user selects the AO by selecting an object (e.g., yellow car, soccer ball, etc.) within an image (e.g., a photograph). The authorized user should keep the selected AO as a secret.

In some embodiments, the AO is the specific object selected or any object of the same type as the object that was selected. For example, in one embodiment, if the object selected is a white soccer ball, the AO is a white soccer ball. But in another embodiment, if the object selected is a white soccer ball, the AO can be any soccer ball (e.g., white, red, or blue).

Additionally, in some embodiments, the object selected by the user can be a composite object, such as a white soccer ball being kicked by a foot, and the resulting AO can be any soccer ball being kicked by a foot or a white ball being kicked by a foot.

In one embodiment, for each photograph in the collection, the AO positioning module 254 determines the selected AO's location in the photograph, and also may determine the size attributes of the photograph, resolution of the photograph, etc., in further respect to device's screen size and direction, as well as security level aspects (described below), and selects where on the display the AO should be displayed.

In some embodiments, ACA 202 includes a security level evaluation (SLE) module 256 that considers user access security class given context of screen unlock, for example determine ratio of number (N) of disclosed photos including valid AO versus disclosed number (M) of photos without AO, AO re-use aspects with respect to deployment position on screen (e.g., it may be advantageous to ensure that the AO is not always displayed in the same location), AO re-use periodicity (e.g., it may be advantageous to have multiple AOs and each AO is displayed at most X% of the time, where X is configurable), etc.

In some embodiments, ACA 202 includes an image manager 258 (which may be on device 102 or implemented by server 112) that orchestrates the authorized user's image data and support AO application with classification of images for object categorization (e.g., making user's photos available over a potential multitude of user devices, etc.). Image manager 258 may acquire image material (e.g., photographs for computer generated images) from the internet in case the user's collection of images is determined to be too small or the selected AO is determined as not having sufficient presence in the user's own image material (e.g., this determination may be based on a given desired security level).

In some embodiments, ACA 202 establishes a set of Y images (e.g., photographs or computer generated images) where N of the Y images include the selected AO and M of the Y images (i.e., Y=N+M) do not include the selected AO. The ratio of M/N can be set by the authorized user. In general, lower values of M provide less security than higher values of M.

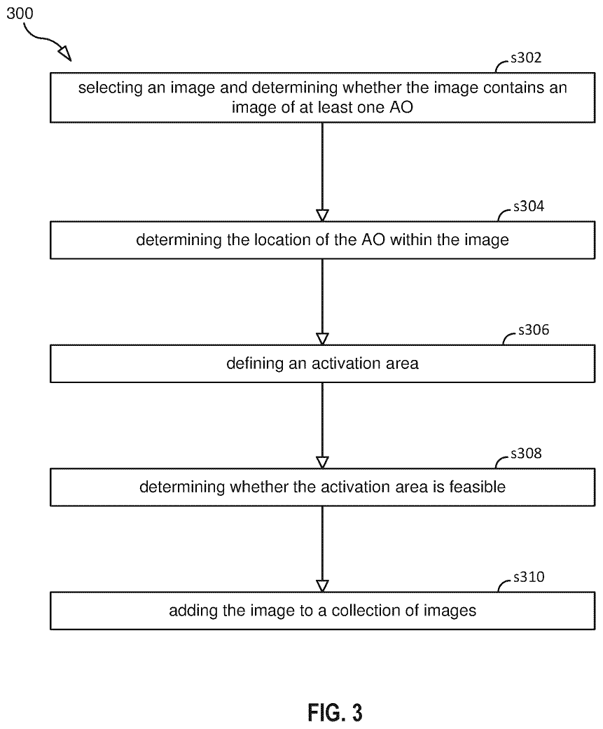

FIG. 3 is a flowchart illustrating a process 300 for a possible use case in which the FR 204 is activated in an activation region associated with an AO. Process 300 may begin with step s302 and may be performed, at least in part, by ACA 202.

Step s302 comprises selecting an image and determining whether the image contains an image of at least one AO. In this step, for example, ACA 202 may use a conventional object recognition ML model to determine whether an image contains an image of an AO (e.g., Apple iOS capability “Classifying Images for Categorization and Search”). If the image does not contain an AO, step s302 is repeated, otherwise the process proceeds to step s304.

In one embodiment the image is selected from a set of images already stored on device 102 (e.g., an authorized user's photo album). In some embodiments, the image is selected from the set of images on device 102, images acquired from a server 112 on network 110, and/or computer generated images. With respect to computer generated images, artificial intelligence (AI) based image rending may be used (see e.g., reference [14]). For example, where the AO is a yellow car, the AI may be asked to “render a photo of a city center, with many roads populated with many vehicles, cars and bikes and pedestrians, where one and only one car is yellow and located at x, y in the image. Render image at 4k.”

Step s304 comprises, determining the location of the AO within the image (e.g., the x, y coordinates of the center of the AO or the top right, etc.).

Step s306 comprises defining an activation area using the determined location. For example, in one embodiment, a radius is predefined that will determine the activation area in combination with the determined location. That is, for example, the activation area may be in the form of a circle centered at the x, y coordinates and having a radius of r, where r is selected or predefined.

In another embodiment, the location of the AO is determined using conventional object recognition techniques that determine a “bounding box” in which the image is located.

That is, the bounding box provides boundaries for the AO. In such an embodiment, the activation area may be co-extensive with the bounding box. In more elaborate solutions where e.g., a pixel-based object (image) segmentation approach is considered, given deployment capabilities of the fingerprint reader technology itself, a more of free-form shaped fingerprint reader deployment shape may be considered. For example, in a beach photo segmented with “sand”, “sea” and “sky” a fingerprint reader may be deployed at “sea”-associated pixels.

Step s308 comprises determining whether the activation area is feasible (i.e., whether the activation area satisfies a predefined condition). For instance, in one embodiment, an activation area is feasible so long as the center of the activation area is at least a threshold distance away from the boarder of display 104. If not feasible, process returns to step s302, otherwise process proceeds to step s310.

Step s310 comprises adding the image to a collection of images. If the collection is now large enough (e.g., if the collection contains N images, where N is configurable) the process ends, otherwise it goes back to step s302.

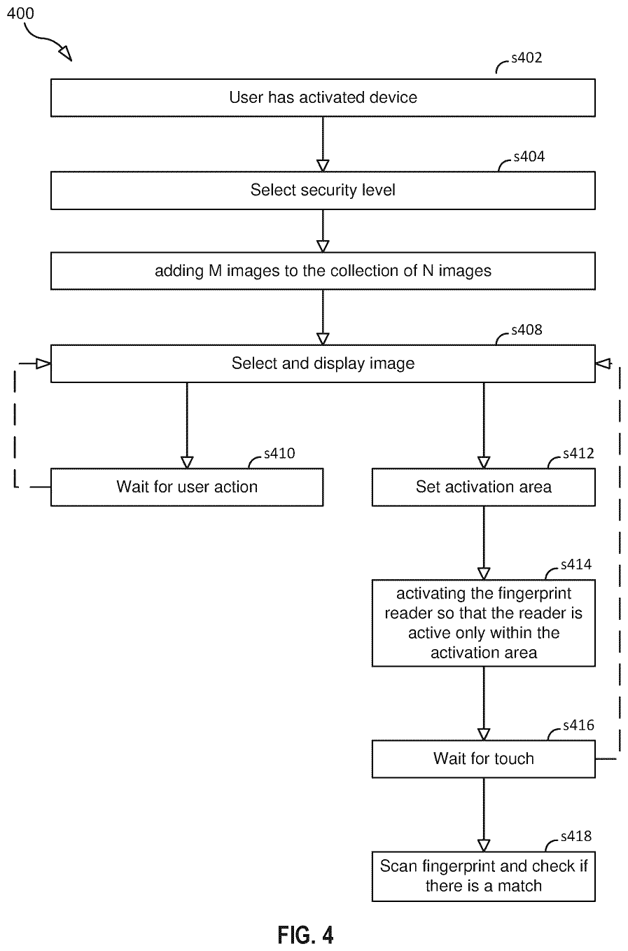

After process 300 is performed and while device 102 is in a locked mode, a user may want to use device 102 (or access the resource guarded by device 102). FIG. 4 is a flowchart illustrating a process 400 for determining whether to allow the user to use the device or access the resource. Process 400 may be performed at least in part by ACA 202 and begin with step s402.

Step s402 comprises detecting that the user has activated device 102 (e.g., detecting that the user has touched display 104 to wake-up the device) while the device is in the locked mode.

Step s404 comprises, in response to detecting the activation of device 102, selecting a security level. The security level may be determined based on the current context (e.g., the location of device and/or the time of day). For example, if device 102 is a mobile device and is located in an unusual location, then the security level may be set to high, whereas if the device is located in an authorized user's home or office, then the security level may be set to low. As another example, if device 102 is a fixed-in-place access device (e.g., an electronic lock for opening a door) and the time-of-day is unusual (e.g., the middle of night), then the security level may be set to high, otherwise set to low.

Step s406 comprises adding M images to the collection of N images produced by performing process 300 (M≥0), where none of the M images contains any AO (i.e., the set of Y images is created). The value of M is set based on the selected security level. In one embodiment, M increases as the security level increases. For example, for the lowest security level M may equal 0, for a middle security level M may equal N/c, and for the highest security level M may equal c×N, where c>1.

Step s408 comprises selecting an image from the set of Y=N+M images and displaying the image on display 104. This selection of an image may be a random selection (e.g., a pseudo-random selection).

In some embodiments, the selected image may be processed (e.g., rotated, zoomed, panned, reduced in size, resolution changed etc.) after it is selected and before it is displayed for the purpose of ensuring that, when the processed image is displayed, the AO is displayed in a preferred location (e.g., any location other than the location in which the AO was most previously displayed for the fingerprint reading purposes). That is, for example, if a deployment location for the AO has been used in a previous screen-unlock, it is recommend that, for a later occasion where the same AO is being used for the screen-unlock, the system may apply zoom, panning and/or rotation so that the AO will appear at some other screen location than used with the previous occasion. Hence, an image-deployment localization re-use periodicity may be considered to avoid same AO for the fingerprint reader to be located at same screen position repeatedly.

If the selected image contains an AO, then the process proceeds to step s412, otherwise the process proceeds to step s410.

Step s410 comprises waiting for the user to take a certain action (e.g., swipe left on display 104). If the user does not take the certain action in a set amount of time, then one of several options may occur: 1) a message is displayed to the user that the user has only X more attempts to unlock device 102 and the process goes back to step s402 or 2) device 102 is placed in a “hibernated” state so that the user must wait some amount of time (e.g., 15 minutes) before process will go back to step s402 or 3) an alarm is activated and/or a hacking notification is sent to an authorized user and/or the authorities. If the user takes the certain action within the set amount of time, then process 400 simply returns to step s402.

Step s412 comprises determining the location the AO in the selected image and, based on the location, setting the activation area as described above (e.g., x, y +radius).

Step s414 comprises activating the FR 204 so that the reader is active only within the activation area. That is, the FR 204 will activate and capture an image if user touches the display screen within the activation area, otherwise the fingerprint reader will remain dormant.

Step s416 comprises waiting for the user to touch the activation area of the display screen. If the user does not touch the activation area in a set amount of time or touches the display screen in an area outside the activation area, then one of several options may occur: 1) a message is displayed to the user that the user has only X more attempts to unlock device 102 and the process goes back to step s402, 2) device 102 is placed in a “hibernated” state so that the user must wait some amount of time (e.g., 15 minutes) before process will go back to step s402 or 3) an alarm is activated and/or the hacking notification is sent. If the user touches the activation area within the set amount of time, then process 400 proceeds to step s418.

In step s418, the user's fingerprint is scanned and a determination is made as to whether the scanned fingerprint matches a fingerprint of an authorized user. If so, the user is given access to device 102 and/or the resource guarded by device 102, otherwise user is not given the access.

### Further Details and Additional or Alternative Embodiments

There are some possibilities for a mechanism using AOs and fingerprint readers in the aspect how (and where on the device) an AO user-interaction is supposed to trigger the FR 204.

One possibility (as outlined in the description in the previous section) may include that the AO serves as the explicit anchor point for the fingerprint reader's deployment position, so that e.g., the FR 204 gets deployed aligned with the AO.

Another possibility is that the AO functions as a trigger interaction point which upon being touched by user triggers activation of the ordinary (e.g., discrete) FR 204, and that FR 204 may be kept active as long as the user is touching the AO (or until the fingerprint is captured). Hence, the user must touch the anchor object and the fingerprint reader simultaneously. In this aspect, the screen disclosing the anchor object may be facing towards the user, whereas the fingerprint reader may be located at basically any other device surface.

In another possibility, two AOs are used-one first AO (e.g., a yellow car) may be the object to touch for the user to trigger activation of the fingerprint reader, and a second AO (e.g., a red ball) may be the intended deployment location for the fingerprint reader. For example, user touches the yellow car displayed on the screen, which device acknowledges, and by that activates FR 204 at the red ball. The third approach may be subject to an increased security level/context where a two-step hidden secret approach may be required; i.e. user carries two levels of hidden secrets; one secret is what first AO1 to press/hold to activate fingerprint reader, and another AO2 where the reader will be deployed.

In some embodiments, instead of step s404 comprising selecting a security level in response to detecting the activation of device 102, step s404 comprises generating an image in response to detecting the activation of device 102 and displaying the generated image.

Accordingly, in this embodiment steps s406 and s408 are not needed. In some embodiments, generating the image comprises: using a random number generator to generate a random value and generating the image based on the random value. For instance if the random value is less than 0.3, then step s404 comprises generating an image that contains an image of the AO, otherwise generating an image that does not contain an image of the AO.

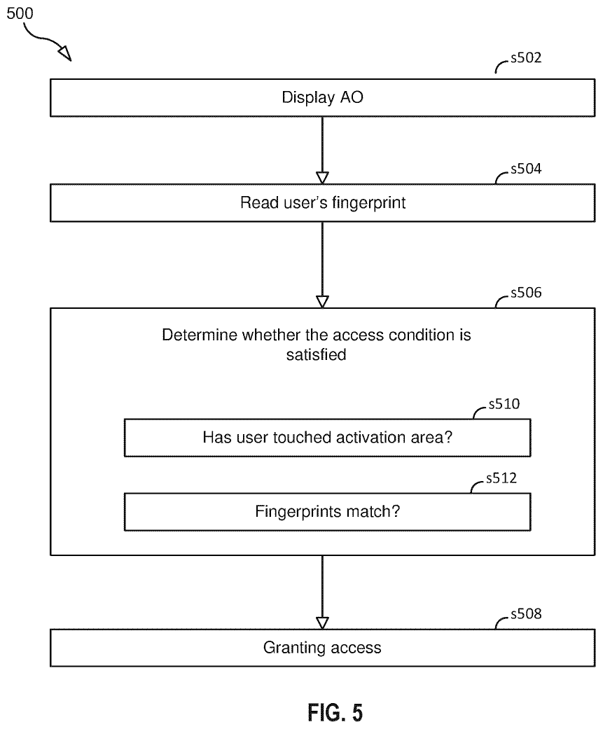

FIG. 5 is a flow chart illustrating a process 500, according to an embodiment, for access control. Process 500 may begin in step s502. Step s502 comprises displaying on the display screen 104 of device 102 an image of an AO that was previously selected by or for an authorized user of the device (e.g., the device or someone else may select the AO for the authorized user). Step s504 comprises obtaining fingerprint information corresponding to a fingerprint of a user seeking to access the device or a resource guarded by the device. Step s506 comprises determining whether an access condition is satisfied. Step s508 comprises granting the user access to the device or the resource as a result of determining that the access condition is satisfied. Step s506 (determining that the access condition is satisfied comprises) determining that the user has touched the display screen in an activation area associated with the AO (step s510) and determining, based on the obtained fingerprint information, that the fingerprint of the user seeking to access the device matches a fingerprint of the authorized user (step s512).

In some embodiments, fingerprint reader 204 is triggered to obtain the fingerprint information in response to the user touching the activation area.

In some embodiments the process also includes, prior to displaying the image of the AO, selecting an image from a set of Y images, wherein Y>1, the selected image comprises the image of the AO, and displaying the image of the AO comprises displaying the selected image. In some embodiments, Y=N+M, wherein N is the total number of images within Y that contain an image of the AO, M is the total number of images within Y that do not contain any image of the AO, and M≥1, and the method further comprises setting M based on a selected security level.

In some embodiments the process also includes forming the set of Y images, wherein forming the set of Y images comprises: including in the set of Y images a first photograph from an existing photo album, wherein the first photograph contains an image of the AO; generating a second image that contain an image of the AO; and including the second image in the set of Y images.

In some embodiments the process also includes, prior to determining that the user has touched the display screen in the activation area: determining the location of the image of the AO within the selected image; and determining the activation area based on the location of the image of the AO within the selected image. In some embodiments FR 204 is deployed only in the activation area. In some embodiments, determining the activation area based on the location of the image of the AO within the selected image comprises determining the activation area based on the location of the image of the AO within the selected image and a radius. For example, using the coordinates of the location of the center of the AO and the radius (r) a shape (e.g., circle of radius r or square with sides of length 2×r) can be formed that has the same center location as the AO and the activation area is set equal to the shape. For instance, the activation area is based on a bounding box in which the AO is located (e.g., in some embodiments, the activation area is co-extensive with the bounding box). In yet another embodiment, the activation area is defined as the segmented AO+X pixels outside of the edge of the AO, thereby making the activation area coextensive with (or slightly larger than) the AO (the segmentation can be done using any of the known segmentation algorithms).

In some embodiments the process also includes, prior to displaying the image of the AO, generating an image based on a random value and displaying the image. In some scenarios, the generated image comprises the image of the AO.

In some embodiments, the fingerprint reader is located outside of the activation area.

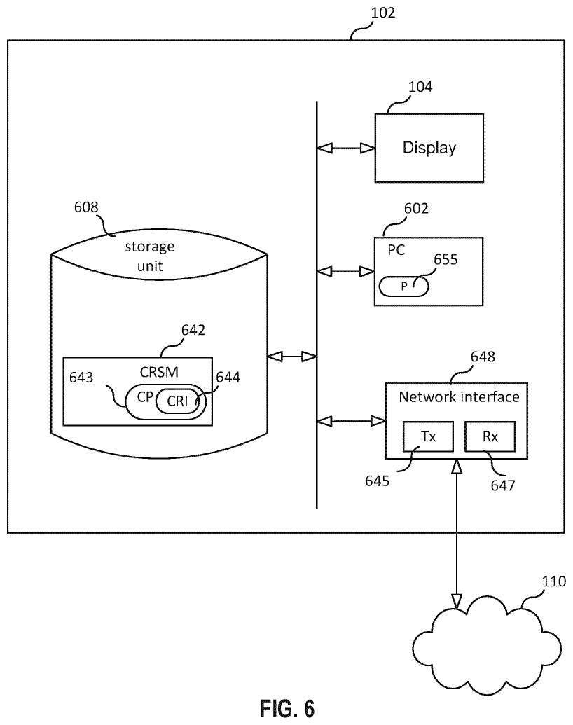

FIG. 6 is a block diagram of device 102, according to some embodiments. As shown in FIG. 6, device 102 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (e.g., device 102 may be a distributed computing apparatus comprising two or more computers or a monolithic computing apparatus consisting of a single computer); at least one network interface 648 (e.g., a physical interface or air interface) comprising a transmitter (Tx) 645 and a receiver (Rx) 647 for enabling device 102 to transmit data to and receive data from other nodes connected to network 110 (e.g., an Internet Protocol (IP) network) to which network interface 648 is connected (physically or wirelessly) (e.g., network interface 648 may be coupled to an antenna arrangement comprising one or more antennas for enabling device 102 to wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes device 102 to perform steps described herein (e.g., steps described herein with reference to the flow charts). In other embodiments, device 102 may be configured to perform steps described herein without the need for code. That is, for example, PC 602 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. Also, as used herein, “a” means “at least one” or “one or more.”

### REFERENCES

[1] US 2014013414 A1 “User-rotatable three-dimensionally rendered object for unlocking a computing device”
[2] U.S. Pat. No. 6,549,194 “Method for secure pin entry on touch screen display”, Hewlett-Packard, 2003)
[3] Apple, “Classifying Images for Categorization and Search” (Apple iOS)
[4] Apple, “Classifying Images with Vision and Core ML,” https://developer.apple.com/documentation/vision/classifying_images_with_vision_and_core_ml
[5] https://developer.apple.com/documentation/vision/recognizing_objects_in_live_capture
[6] “Face recognition” (apple iOS) https://machinelearning.apple.com/research/recognizing-people-photos
[7] YOLO object recognition framework, https://arxiv.org/abs/1804.02767
[8] YOLO COTS solutions, by e.g. Ultralytics, https://github.com/ultralytics/ (YOLO v3 . . . v8)
[9] Amazon Rekognition, https://aws.amazon.com/rekognition/image-features/
[10] “What is the difference between Object Detection and Image Segmentation? . . . and when to use which?”, Towards Data Science, Joos Korstanje, Jul. 29, 2020 (a general read on object detection vs. object segmentation) https://towardsdatascience.com/what-is-the-difference-between-object-detection-and-image-segmentation-ee746a935cc1
[11] Image Classification vs. Object Detection vs. Image Segmentation, Pulkit Sharma, Analytics Vidhya, Aug. 21, 2019, https://medium.com/analytics-vidhya/image-classification-vs-object-detection-vs-image-segmentation-f36db85fe81
[12] Apple picks up a new patent for an under-display Touch ID sensor, Oliver Haslam, iMore, Sep. 8, 2020, https://www.imore.com/apple-picks-new-patent-under-display-touch-id-sensor.

[13] U.S. Pat. No. 10,768,751 B2, “Electronic device including optical image sensor having metallization layers and related methods,” Apple.

[14] https://huggingface.co/spaces/stabilityai/stable-diffusion

1. A method for access control, comprising:
displaying on a display screen of a device an image of an anchor object; (AO) that was previously selected by or for an authorized user of the device;
obtaining fingerprint information corresponding to a fingerprint of a user seeking to access the device or a resource guarded by the device;
determining that an access condition is satisfied; and
granting the user access to the device or the resource as a result of determining that the access condition is satisfied, wherein
determining that the access condition is satisfied comprises:
determining that the user has touched the display screen in an activation area associated with the AO; and
determining, based on the obtained fingerprint information, that the fingerprint of the user seeking to access the device matches a fingerprint of the authorized user.

2. The method of claim 1, wherein
a fingerprint reader is triggered to obtain the fingerprint information in response to the user touching the activation area.

3. The method of claim 1, wherein
the method further comprises, prior to displaying the image of the AO, selecting an image from a set of Y images,
Y>1,
the selected image comprises the image of the AO, and
displaying the image of the AO comprises displaying the selected image.

4. The method of claim 3, wherein
Y=N+M,
N is the total number of images within Y that contain an image of the AO,
M is the total number of images within Y that do not contain any image of the AO,
M>1, and
the method further comprises setting M based on a selected security level.

5. The method of claim 3, wherein
the method further comprises forming the set of Y images, and forming the set of Y images comprises:
including in the set of Y images a first photograph from an existing photo album, wherein the first photograph contains an image of the AO;
generating a second image that contains an image of the AO; and
including the second image in the set of Y images.

6. The method of claim 1, wherein
the method further comprises:
prior to determining that the user has touched the display screen in the activation area, determining the location of the image of the AO within the selected image; and
determining the activation area based on the location of the image of the AO within the selected image.

7. The method of claim 6, wherein
a fingerprint reader is triggered to obtain the fingerprint information in response to the user touching the activation area, and
the fingerprint reader is deployed only in the activation area.

8. The method of claim 6, wherein
determining the activation area based on the location of the image of the AO within the selected image comprises:
determining the activation area based on the location of the image of the AO within the selected image and a radius, or
determining a bounding box in which the AO is located, wherein the activation area is coextensive with the bounding box.

9. The method of claim 1, wherein
the method further comprises:
prior to displaying the image of the AO, generating an image based on a generated random value; and
displaying the image, and
the generated image comprises the image of the AO.

10. The method of claim 2, wherein the fingerprint reader is located outside of the activation area.

11. A device for access control, the device comprising a display screen and being configured to perform a method comprising:
displaying on the display screen an image of an anchor object (AO) that was previously selected by or for an authorized user;
obtaining fingerprint information corresponding to a fingerprint of a user seeking to access the device or a resource guarded by the device;
determining that an access condition is satisfied; and
granting the user access to the device or the resource as a result of determining that the access condition is satisfied, wherein
determining that the access condition is satisfied comprises:
determining that the user has touched the display screen in an activation area associated with the AO; and
determining, based on the obtained fingerprint information, that the fingerprint of the user seeking to access the device matches a fingerprint of the authorized user.

12. The device of claim 11, wherein
the device further comprises a fingerprint reader, and
the fingerprint reader is triggered to obtain the fingerprint information in response to the user touching the activation area.

13. The device of claim 11, wherein
the method further comprises, prior to displaying the image of the AO, selecting an image from a set of Y images,
Y>1,
the selected image comprises the image of the AO, and
displaying the image of the AO comprises displaying the selected image.

14. The device of claim 13, wherein
Y =N +M,
N is the total number of images within Y that contain an image of the AO,
M is the total number of images within Y that do not contain any image of the AO,
M>1, and
the method further comprises setting M based on a selected security level.

15. The device of claim 13, wherein
the method further comprises forming the set of Y images, and
forming the set of Y images comprises:
including in the set of Y images a first photograph from an existing photo album, wherein the first photograph contains an image of the AO;
generating a second image that contains an image of the AO; and
including the second image in the set of Y images.

16. The device of claim 11, wherein
the method further comprises, prior to determining that the user has touched the display screen in the activation area:
determining the location of the image of the AO within the selected image; and
determining the activation area based on the location of the image of the AO within the selected image.

17. The device of claim 16, wherein
a fingerprint reader is triggered to obtain the fingerprint information in response to the user touching the activation area, and
the fingerprint reader is deployed only in the activation area.

18. The device of claim 16, wherein
determining the activation area based on the location of the image of the AO within the selected image comprises:
determining the activation area based on the location of the image of the AO within the selected image and a radius, or
determining a bounding box in which the AO is located, wherein the activation area is coextensive with the bounding box.

19. The device-of of claim 11, wherein
the method further comprises, prior to displaying the image of the AO, generating an image based on a generated random value and displaying the image, wherein the generated image comprises the image of the AO.

20. The device of claim 12, wherein the fingerprint reader is located outside of the activation area.

21-22. (canceled)
